(19) United States
(12) Patent Application Publication
(10) Pub. No.: US 2010/0326367 A1
(43) Pub. Date: Dec. 30, 2010

(54) Interconnected claw post

(76) Inventor: Donald Kevin Wedertz, San Mateo, CA (US)

Correspondence Address: Donald K. Wedertz, 2311 S. Norfolk St., San Mateo, CA, 94403, US

(21) Appl. No.: 12/660,298

(22) Filed: Feb. 24, 2010

Related U.S. Application Data
(60) Provisional application No. 61/209,679, filed on Mar. 10, 2009.

(51) Int. Cl. A01K 15/02

(52) U.S. Cl. 119/706

(57) ABSTRACT

This interconnected claw post is made so each piece can be replaced. The cat owner now has options to choose a carpet color and thickness they may want to, use to replace carpet on the base, vertical tube or platform that needs replacing on the interconnected claw post. Carpet that covers the interconnected claw post's vertical piece can also be used to cover worn carpet on a vertical piece of a different manufactured claw post or cover a worn vertical section on a cat tree, thereby preserving the functionality of different manufactured claw posts. The consumer can now enjoy options and save money.

This description is referenced to Provisional application Ser. No.: 61/209,679 dated: Mar. 10, 2009. My invention is called the “Interconnected Claw Post”, featuring six (6) interconnected parts, whereby each part is replaceable and so named: the base, the base carpet, the tube-post, the carpet tube, the platform, and the pocket carpet.

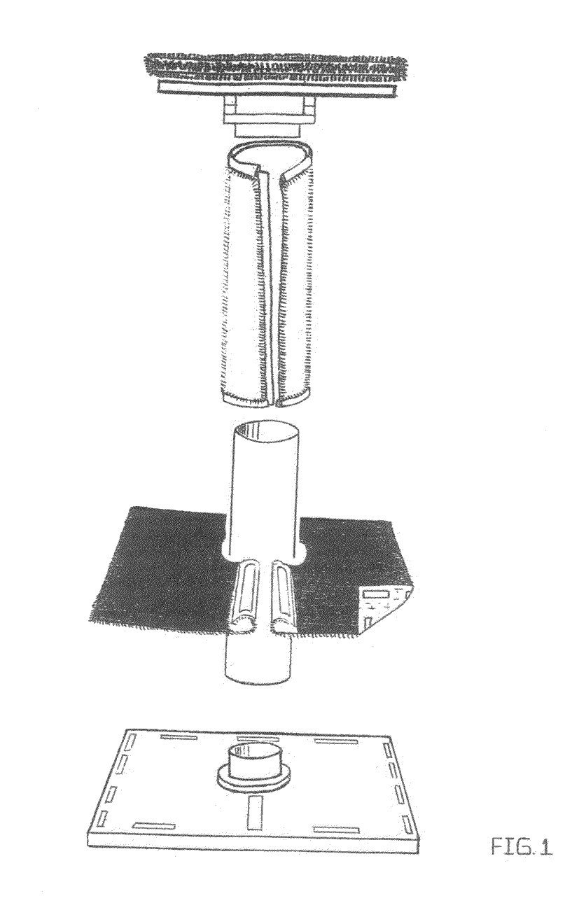

The base is the bottom piece that rests on the floor. The base can be made of many materials. FIG. 1 shows an exploded view of the interconnected claw post. Numeral 1shows a frontal view the base shape. Numeral 1A shows a frontal view of the coupler attached to the base's top surface in the middle area, for interconnecting purposes. Numeral 1B shows a Velcro strip near a corner; that is typical at each corner, while other strips are near and parallel to the base's outer edges and between the coupler and outer edge.

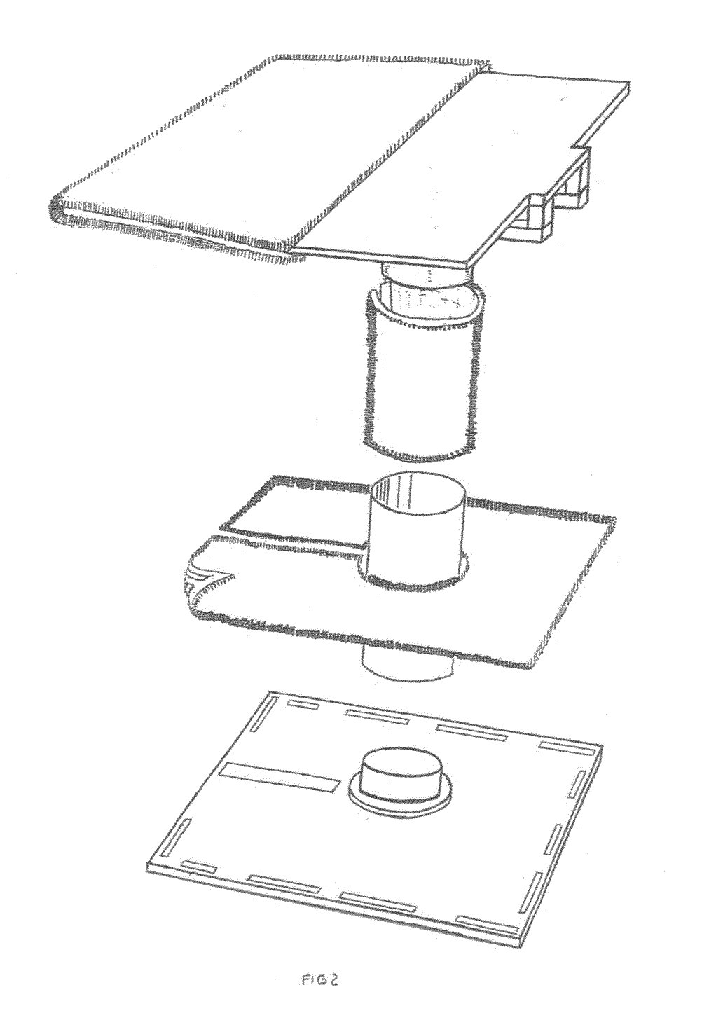

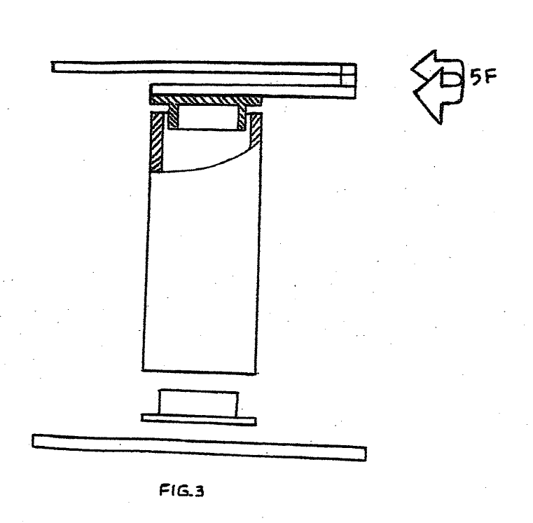

FIG. 2 is an exploded view showing the right side. Numeral 1 shows a view of the base. Numeral 1A shows the base coupler, as numeral 1B shows Velcro strips near a corner, while other strips are near and parallel the base's outer edge and between the coupler and outer edge. All strips hold a base covering in place. FIG. 3, numeral 1 shows the base's right profile view, as numeral 1A shows a right profile of its coupler.

This carpet covers the base for cat activity. When worn out, it is replaceable. If a room's color and/or furniture decor change, the base carpet can be changed to coordinate with the room's color/decor. FIG. 1, numeral 2 shows a frontal view of the base carpet. Numeral 2A shows a separation of carpet or open seam, pealed back and away from each other; midway along the carpets width. The opening spans from the outer edge to an open circular area where the base coupler interconnects with a hollow tube. The hollow tube is referred to as a tube-post in the descriptive progression. Numeral 2A also shows a Velcro strip on the back matt; paralleling the open seam's edge. This is on the opposite seam's edge too. Numeral 2B shows a corner of carpet pulled back to reveal Velcro strips near a corner's back matted area. This is typical near each corner area.

FIG. 2, numeral 2 shows the base carpet's right view. Numeral 2A shows a separation of carpet opened slightly to show its edges. When the carpet lays flat on the base, the open seam edges are held close-together via underlying Velcro strips on the bottom matted surface forms an invisible seam; FIG. 11 shows. The base carpets Velcro mate with the base Velcro; thereby blending the seam area with the surrounding carpet. FIG. 2, numeral 2B shows a corner of carpet pulled back to reveal Velcro strips on the back matt, near the corner's area.

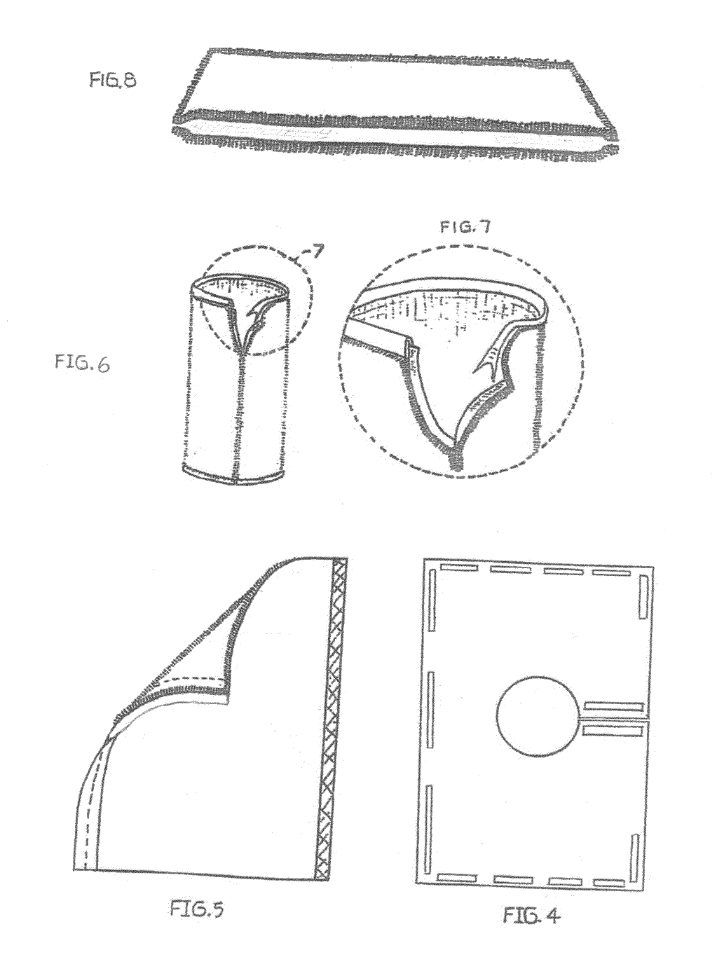

FIG. 4, numeral 2 shows a plan view of the base carpet's bottom matted surface. Numeral 2A shows the separation of carpet's outer corners and its open seam leading to the open circular area. Numeral 2B shows Velcro strips near a corner of carpet; typical near all corners. Other strips are uniformly placed along the carpet's outer edge and along the separation of carpet edges. The open circular area does not need Velcro. When the carpet needs to be replaced, it is easy to find a corner of the separation of carpet at FIG. 4, numeral 2A. Pull either corner up and off from the underlying base Velcro strip, to open the seam and the rest of the carpet follows to come off and from around the tube-post within seconds. Installation is a reversal of this process.

FIG. 1, numeral 3 shows the tube-post frontal view; as its lower-middle section is slightly obscured by the base carpet, depicting the tube-post's lower area has passed through an open space in the base carpet's middle area. FIG. 2, numeral 3 shows a right view of the tube-post passing through the base carpets middle area. FIG. 3, numeral 3 shows the tube-post's right profile. Either end of the tube-post can interconnect with the base coupler while the opposite end can be capped off; with a flat cover, or remain open to support a platform. Numeral 3A shows a cross section of the tube-post's upper area as the platform coupler enters. The elongated hollow tube is very sturdy as a light weight post.

This hollow tube-post interconnects to the base coupler to stand up-right and provides a vertical form for a covering, for cat activity. The top area of the hollow tube can support a platform as an optional piece. The tube-post is replaceable and can be made from numerous materials. A hard ABS hollow tubular material is most popular for its light weight and sturdiness. Either end of the tube-post can connect to the base coupler, while the opposite end can remain bare, be capped off, or be useable for other attachments.

FIG. 1, numeral 4 shows the carpet tube's frontal view and vertical seam open. This carpet completely covers the tube-post for one or more cats to grab onto and stretch out, rub against and claw. When worn out, the carpet tube is replaceable. When a room's color and/or furniture decor change, the carpet tube can be changed also, to coordinate with the room. This carpet tube can also preserve the functionality of a different manufactured claw post or scratcher post and a cat tree by covering over their worn vertical piece or worn vertical section of a cat tree.

FIG. 2, numeral 4 shows the carpet tube's left view. This angle also shows the carpet Velcro connections; near the top, are partially open. FIG. 5, numeral 4A; pg.4 of 6 drawings, shows a plan view of the carpet tube lying flat and completely open with its matted side up. Numeral 4B shows the carpet's upper left corner is pulled up and towards the carpet's imaginary vertical center-line; at a 180 degree diagonal angle from its original flat position, to reveal the top surface of Velcro immediately next to and following along the carpet's end-edge.

Half of the Velcro's width is hidden, but attached to the carpet's back matted surface, while the other half visibly extends beyond the carpets end-edge. Its length begins at the carpets corner and matches the carpets length. Numeral 4C shows the Velcro's width, relative to the carpet's end-edge position underneath. Numeral 4D shows the carpet's lower left corner and Velcro strip meet exactly.

Numeral 4E shows the opposite end of the carpet laying flat and a Velcro's top surface facing up, as one edge is exactly next to and parallels the carpets end-edge length; whereby, the Velcro's back surface area is attached to the carpets matt.

FIG. 6, numeral 4F, shows the carpet is curled into a tube; hence the term . . . ”Carpet Tube” and numeral 4G shows a seam depicting both carpet ends are held together via underlying Velcro strips. Holding the carpet ends together, results in vertical structure stability for the carpet, to stand upright on its own. Numeral 7 is a circular dotted area to focus on an uncovered matted edge. FIG. 7 shows a magnification of that area to be covered and two Velcro strips awaiting connection.

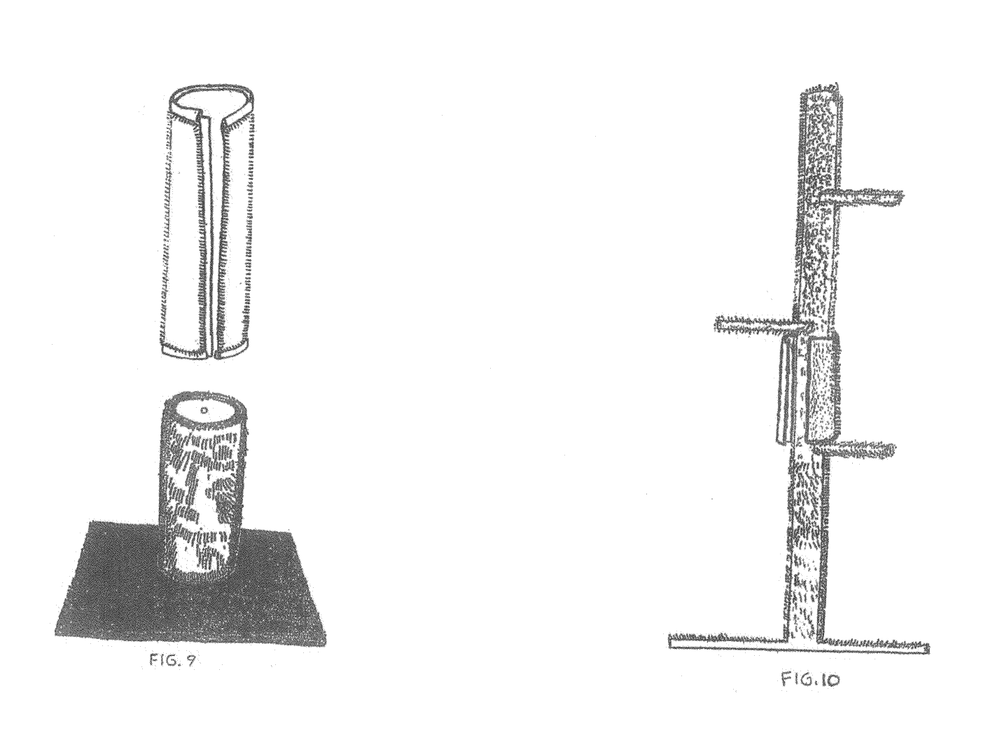

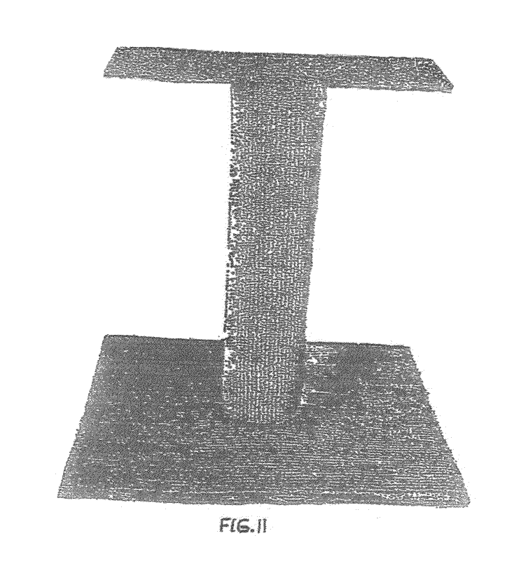

Covering or binding the carpet's matted edge prevents fibers from unraveling and also prevents any finger or skin from abrasion if they inadvertently rubbed against or moved along the matt's rough surface. To remove the carpet tube, slide it up and off the tube-post or separate its Velcro strips and unwrap the carpet from around the post. FIG. 9, numeral 4H; pg.5 of 6 drawings, shows carpet tube open and in position to cover a worn vertical piece of a different manufactured claw post or scratcher post. FIG. 10, numeral 41 shows the carpet tube wrapped around a worn vertical section on a cat tree, thereby preserving its functionality.

FIG. 1, numeral 5 shows the platform's frontal view with its lower associated pieces. This platform sits on top of the tube-post and can be rotated in 360 degrees for limited space purposes or remain off at the owner's discretion. It is covered with replace-able carpet that provides a play or rest area and can be clawed by one or more cats.

FIG. 1, numeral 5B is the lower framework “spacer”. It creates room between the platform and the lower framework for a covering to slide into position and envelope both surfaces of the platform. Numeral 5C is the lower framework that attaches to the spacer. Numeral 5D is the platform coupler. It rests inside the top-area of the tube-post to pre-vent the platform from rocking back and forth.

FIG. 2, numeral 5, shows a right perspective view of the platform and its associated parts however, the framework's full side view is obstructed by the platform. FIG. 2, numeral 5A shows the platform's aft tab area. This is an integral area that provides a lower surface for the framework; numeral 5C, and its spacer; numeral 5B to connect to. Numeral 5D is a lower view of the platform coupler. Its upper section is obstructed by the platform. FIG. 3, numeral 5D; pg. 3 of 6 drawings, shows a cross section of the coupler as it connects to the platform's lower framework and rests in the top of the tube-post. The coupler interconnects inside the top area of the tube-post is deep enough to provide stability about the platform's vertical axis, as its flange controls horizontal stability when the platform is either still or turned. Numeral 5E shows a side view of the “space” between the framework and the platform. Numeral 5F shows arrows depicting the platform's plane of rotation about a horizontal plane.

FIG. 1, numeral 6 shows the pocket carpet's front view. The pocket carpet covers the platform by sliding on it and enveloping its entire top and bottom surface so one or more cats can rest or play on it and claw it. Any carpet material can be used when cut to size and folded in half to produce a top and bottom piece; two useable surfaces.

FIG. 2, numeral 6 shows a left perspective view of the pocket carpet as it is nearly halfway on the platform. FIG. 8, numeral 6 shows the pocket carpet folded; whereby it's top surface is laying on the bottom surface. FIG. 8, numeral 6A shows both left and right side seam front edges. Any matted carpet can be used and as the length is folded in half, two layers distinguish a top and bottom surface as well as distinguishing a left and right side, a front area opposite the folded side. Both top and bottom end-edges of the left and rights sides are sealed, as the remaining two edges at numeral 6B are unsealed to form an air space or pocket of air, hence the term . . . “Pocket Carpet”. Numeral 6B also identifies the aft area. To cover the platform, the pocket area is opened slightly and positioned near the platform's left or right front corner.

After the pocket area begins to cover a corner, its matted surface will lay on top of the platform's surface and the carpet can slide over the platform's entire surface, until the pocket carpet completely envelopes the platform. FIG. 2, numeral 6 shows the pocket carpet's position is halfway on the platform.

When the carpet needs to be replaced, slide it completely off, turn the carpet over, so the bottom surface becomes the “new” top surface and slide the carpet back on. The platform is available for use. FIG. 11 shows the interconnected claw post is ready!

What is claimed is:

1. This cat clawing apparatus is comprised of six (6) independent, interconnected and replaceable pieces; whereby the first on piece is named the base which lays flat on the floor and employs a coupler that is attached to its upper surface; near its center area, connecting to a second (2^{nd}) piece named the post, which can be a solid material or hollow tubing, having two ends, where either end can connect to the base coupler to support the post in an upright manner, where its longitudinal axis is perpendicular to the base plane, for so named post's upper edge connects to another coupler that is to and supports a third (3^{rd}) piece namely a platform, which can be manually rotated slowly in 360 degrees about its horizontal axis while a fourth (4^{th}) piece known as the pocket carpet of fibrous matted material, covers the platform for one or multiple cats to rest on, play on, or claws the carpeted area and so named pocket carpet is created by folding carpet in half, so the upper and lower surfaces lay on each other to show six outer edges; whereby four (4) are sealed to become two side seams, while two other outer edges remain unsealed, thereby producing an open area or air pocket between the two side seams which determines the front area of pocket carpet which easily slides onto and covers the platform and when its top surface needs replacing, slide the entire pocket carpet off, turn it over, so bottom surface becomes the new top surface and slide the pocket carpet back on as a fifth (5) replaceable piece namely a base carpet, covers the base, for one or more cats to rest on, play on or claw at and for the base carpet to lay flat on the base, it's center area has a circular opening for the post to access the base coupler and such opening has an edge that leads to a separation of material or open seam which extends outward towards the carpets very outer edge to facilitate carpet removal from the base, from around its coupler and from around the post as the sixth (6^{th}) piece named the carpet tube; a matted fibrous material, covers the post for clawing and so named carpet is formed into a hollow tube, where its end-edges meet, Velcro strips are affixed onto and along the end-edges to close hollow tube, whereby tube slides onto post or if the tube is already closed, its two end-edges can be separated and wrap the material around the post, then reconnect its end-edges to close hollow tube around the post.

2. The cat clawing apparatus of claim 1 whereby the carpet tube can renew a different manufactured claw post by covering over its worn-out carpeted post.

3. The cat clawing apparatus of claim 2 whereby the carpet tube can open and wrap around a worn-out vertical section of carpet on a cat tree, thereby renewing its functionality.
